(19) United States
(12) Patent Application Publication
(10) Pub. No.: US 2024/0058204 A1
(43) Pub. Date: Feb. 22, 2024

(54) INTERACTION METHOD AND SYSTEM FOR SEX TOYS

(71) Applicant: Cunmi Robot Technology (Shenzhen) Co., Ltd, Guangdong (CN)

(72) Inventor: qiuming LIU, Guangdong (CN)

(73) Assignee: Cunmi Robot Technology (Shenzhen) Co., Ltd, Guangdong (CN)

(21) Appl. No.: 17/891,158

(22) Filed: Aug. 19, 2022

(51) Int. Cl. A61H 19/00

(52) U.S. Cl. CPC A61H 19/30; A61H 19/40; A61H 2201/0153; A61H 2201/5012; A61H 2201/5071; A61H 2201/5082; A61H 2201/5097

(57) ABSTRACT

The invention relates to an interaction method and system for sex toys. The interaction method for sex toys comprises the following steps: acquiring use parameters of a first sex toy, uploading the use parameters of the first sex toy, issuing instructions according to the acquired use parameters, and running a second sex toy according to the instructions. By adoption of the interaction method and system for sex toys, sex toys can be remotely or separately used by users more conveniently based on the network.

### BACKGROUND OF THE INVENTION

### 1. Technical Field

The invention relates to an interaction method and system, in particular to an interaction method and system for sex toys.

### 2. Description of Related Art

At present, most sex toys are used locally, and cannot be used through the network. With the application of the network, sex toys can be remotely or separately used by users more conveniently based on the network to fulfill a better experience effect.

### BRIEF SUMMARY OF THE INVENTION

The technical issue to be settled by the invention is to provide an interaction method and system for sex toys to solve the technical problem that, in the prior art, sex toys cannot be used remotely or separately.

One technical solution of the invention is as follows: an interaction method for sex toys is constructed, comprising the following steps:
Acquiring use parameters of a first sex toy: acquiring a working length parameter of the first sex toy and a work speed parameter of the first sex toy by a displacement sensor;
Uploading the use parameters of the first sex toy: uploading the use parameters of the first sex toy, including the working length parameter of the first sex toy and the work speed parameter of the first sex toy, to a cloud server through a first communication module;
Issuing instructions according to the acquired use parameters: generating, by the cloud server, a running instruction according to the received use parameters of the first sex toy, generating, by the cloud server, a work speed instruction of a second sex toy according to the work speed parameter, generating, by the cloud server, a working length instruction of the second sex toy according to the working length parameter, and sending the running instruction to the second sex toy matched with the first sex toy; and
Running the second sex toy according to the instructions: running the second sex toy according to the received running instruction of control a work speed and a working length of the second sex toy.

Further, the interaction method for sex toys further comprises: establishing a communication connection between the first sex toy and a first intelligent mobile terminal, and uploading information to the cloud server through the first intelligent mobile terminal.

Further, the interaction method for sex toys further comprises: establishing a communication connection between the second sex toy and a second intelligent mobile terminal, and acquiring information sent from the cloud server through the second intelligent mobile terminal.

Further, the interaction method for sex toys further comprises: acquiring a work force intensity parameter of the first sex toy by a pressure sensor.

Further, the interaction method for sex toys further comprises: acquiring a working temperature of the first toy by a temperature sensor, or acquiring one or more of use action and shape parameters of a first sex toy body by an infrared sensor.

Another technical solution of the invention is as follows: an interaction system for sex toys is constructed, comprising a first sex toy, a second sex toy and a cloud server, wherein the first sex toy comprises a first sex toy body, and a displacement sensor and a first communication module disposed in the first sex toy body; the second sex toy comprises a second sex toy body, and a drive module, a vibration module and a second communication module disposed in the second sex toy body; the displacement sensor acquires a working length parameter of the first sex toy body and then acquires a work speed parameter of the first sex toy; the first communication module uploads use parameters of the first sex toy to the cloud server, and the use parameters include a work force intensity parameter of the first sex toy and a working length parameter of the first sex toy; the cloud server generates a running instruction according to the received use parameters of the first sex toy, generates a work speed instruction of the second sex toy according to the work speed parameter and generates a working length instruction of the second sex toy according to the working length parameter, and the second communication module sends the running instruction to the second sex toy matched with the first sex toy; and the second sex toy runs according to the received running instruction, controls the drive module to control a working length of the second sex toy body according to the working length instruction, and controls the vibration module to control a work speed of the second sex toy body according to a work force intensity instruction.

Further, the interaction system for sex toys further comprises: a first intelligent mobile terminal, wherein the first sex toy establishes a communication connection with the first intelligent mobile terminal and uploads information to the cloud server through the first intelligent mobile terminal.

Further, the interaction system for sex toys further comprises a second intelligent mobile terminal, wherein the second sex toy establishes a communication connection with the second intelligent mobile terminal and acquires information sent from the cloud server through the second intelligent mobile terminal.

Further, the first sex toy further comprises a pressure sensor, and the first sex toy acquires a work force intensity parameter of the first sex toy body through the pressure sensor.

Further, the interaction system for sex toys further comprises a second intelligent mobile terminal, wherein the second sex toy establishes a communication connection with the second intelligent mobile terminal and acquires multiple running instructions generated according to parameter information of the first sex toy through the second intelligent mobile terminal.

Further, multiple first sex toys are configured, multiple second sex toys are configured, and one or more of the first sex toys are used in cooperation with one or more of the second sex toys separately.

The invention has the following technical effects: an interaction method and system for sex toys are constructed; the interaction method for sex toys comprises the following steps: acquiring use parameters of a first sex toy; acquiring a working length parameter and a work speed parameter of the first sex toy by a displacement sensor; uploading the use parameters of the first sex toy: uploading the use parameters of the first sex toy, including the working length parameter of the first sex toy and the work speed parameter of the first sex toy, to a cloud server through a first communication module; issuing instructions according to the acquired use parameters: generating, by the cloud server, a running instruction according to the received use parameters of the first sex toy, generating, by the cloud server, a work speed instruction of a second sex toy according to the work speed parameter of the cloud server, generating, by the cloud server, a working length instruction of the second sex toy according to the working length parameter, and sending the running instruction to the second sex toy matched with the first sex toy; and running the second sex toy according to the instructions: running the second sex toy according to the received running instruction, so as to control a work speed and a working length of the second sex toy. By adoption of the interaction method and system for sex toys, sex toys can be remotely or separately used by users more conveniently based on a network, and the experience effect is better.

### BRIEF DESCRIPTION OF THE SEVERAL VIEWS OF THE DRAWINGS

FIG. 1 is a structural diagram of the invention.

FIG. 2 is a structural diagram of a preferred embodiment of the invention.

### DETAILED DESCRIPTION OF THE INVENTION

The technical solutions of the invention will be further described below in conjunction with specific embodiments.

According to one technical solution of the invention, an interaction method for sex toys is constructed, comprising the following steps:

Acquiring use parameters of a first sex toy: acquiring a working length parameter of the first sex toy and then acquiring a work speed parameter of the first sex toy, by a displacement sensor.

The specific implementation process is as follows: a displacement sensor is disposed in the first sex toy, a working length parameter of a first sex toy body of the first sex toy is acquired by the displacement sensor, and a work speed parameter of the first sex toy body of the first sex toy is acquired according to clock information and a displacement of the displacement sensor.

Uploading the use parameters of the first sex toy: uploading the use parameters of the first sex toy, including the working length parameter of the first sex toy and the work speed parameter of the first sex toy, to a cloud server through a first communication module.

The specific implementation process is as follows: the use parameters of the first sex toy are uploaded to the cloud server through a communication module, and the use parameters of the first sex toy includes the working length parameter of the first sex toy and the work speed parameter of the first sex toy.

Issuing instructions according to the acquired use parameters: generating, by the cloud server, a running instruction according to the received use parameters of the first sex toy, generating, by the cloud server, a work speed instruction of a second sex toy according to the work speed parameter, generating, by the cloud server, a working length instruction of the second sex toy according to the working length parameter, and sending the running instruction to the second sex toy matched with the first sex toy.

The specific implementation process is as follows: the cloud server generates a running instruction according to the received use parameters of the first sex toy, generates a work speed instruction of a second sex toy according to the work speed parameter, generates a working length instruction of the second sex toy according to the working length parameter, and sends the running instruction to the second sex toy matched with the first sex toy. The first sex toy is used in cooperation with the second sex toy.

Running the second sex toy according to the instructions: running the second sex toy according to the received running instruction to control a work speed and a working length of the second sex toy.

The specific implementation process is as follows: the second sex toy runs according to the received running instruction, the work speed instruction in the running instruction controls a running speed of a second sex toy body, and the working length instruction in the running instruction controls a running length of the second sex toy body.

In a preferred embodiment of the invention, the interaction method for sex toys further comprises: establishing a communication connection between the first sex toy and a first intelligent mobile terminal, and uploading information to the cloud server through the first intelligent mobile terminal. The specific implementation process is as follows: the first intelligent mobile terminal is provided with an exclusive APP or applet, the first sex toy is connected to the first intelligent mobile terminal through a communication module, the acquired use parameters of the first sex toy are uploaded to the exclusive APP or applet of the first intelligent mobile terminal, and the first intelligent mobile terminal transmits the use parameters of the first sex toy to the cloud server through the APP or applet.

In a preferred embodiment of the invention, the interaction method for sex toys further comprises: establishing a communication connection between the second sex toy and a second intelligent mobile terminal, and acquiring information sent from the cloud server through the second intelligent mobile terminal. The specific implementation process is as follows: the second intelligent mobile terminal is provided with an exclusive APP or applet, the second sex toy is connected to the second intelligent mobile terminal through a communication module, the cloud server transmits the generated running instruction of the second sex toy to the APP or applet of the second intelligent mobile terminal, and then the second intelligent mobile terminal transmits the running instruction of the second sex toy to the second sex toy.

In a preferred embodiment of the invention, the interaction method for sex toys further comprises: acquiring a work force intensity parameter of the first sex toy by a pressure sensor. The pressure sensor is disposed on an inner wall of the first sex toy body, and a work force intensity of the first sex toy body is acquired by the pressure sensor.

In a preferred embodiment of the invention, the interaction method for sex toys further comprises: acquiring a working temperature of the first sex toy by a temperature sensor, or acquiring one or more of use action and shape parameters of the first sex toy by an infrared sensor. The specific implementation process is as follows: a temperature sensor is disposed in the first sex toy body, and a use temperature sensor of the first sex toy body is acquired by the temperature sensor. An infrared sensor is disposed on the first sex toy body, and use action and shape parameters of the first sex toy are acquired by the infrared sensor. These parameters are use parameters of the first sex toy and are uploaded to the cloud server to form corresponding information, which is then transmitted to the second sex toy matched with the first sex toy.

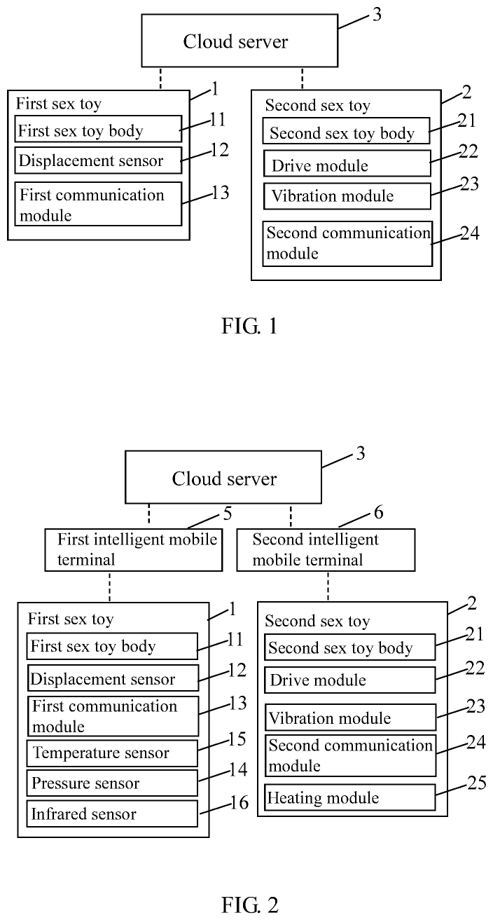

As shown in FIG. 1, another technical solution of the invention is as follows: an interaction system for sex toys is constructed, comprising a first sex toy 1, a second sex toy 2, and a cloud sever 3, wherein the first sex toy 1 comprises a first sex toy body 11, and a displacement sensor 12 and a first communication module 13 disposed in the first sex toy body 11; the second sex toy 2 comprises a second sex toy body 21, and a drive module 22, a vibration module 23 and a second communication module 24 disposed in the second sex toy body 21; the displacement sensor 12 acquires a working length parameter of the first sex toy body 11 and then acquires a work speed parameter of the first sex toy 1; the first communication module 13 uploads use parameters of the first sex toy 1, including a work force intensity parameter of the first sex toy 1 and the working length parameter of the first sex toy, to the cloud server 3; the cloud server 3 generates a running instruction according to the use parameters of the first sex toy 1, generates a work speed instruction of the second sex toy 2 according to the work speed parameter and generates a working length instruction of the second sex toy 2 according to the working length parameter, and the second communication module 2 sends the running instruction to the second sex toy 2 matched with the first sex toy 1; and the second sex toy 2 runs according to the received running instruction, controls the drive module 22 to control a working length of the second sex toy body 21 according to the working length instruction, and controls the vibration module 23 to control a work speed of the second sex toy body 21 according to the work force intensity instruction.

The specific implementation process is as follows: the first sex toy 1 comprises a first sex toy body 11, and a displacement sensor 12 and a first communication module 13 disposed in the first sex toy body 11; the displacement sensor 12 acquires a working length parameter of the first sex toy body 11; the displacement sensor acquires the working length parameter of the first sex toy body of the first sex toy and acquires a work speed parameter of the first sex toy body 11 of the first sex toy 1 according to time information and a displacement parameter of the displacement sensor 12. The first communication module 13 transmits the use parameters of the first sex toy 1 to the cloud server 3, and the use parameters include a work force intensity parameter of the first sex toy 1 and a working length parameter of the first sex toy. The cloud server 3 generates a running instruction according to the received use parameters of the first sex toy 1, generates a work speed instruction of the second sex toy 2 according to the work speed parameter, generates a working length instruction of the second sex toy 2 according to the working length parameter, and sends the running instruction to the second sex toy 2 matched with the first sex toy 1. The second sex toy 2 runs according to the received running instruction, controls the drive module 22 to control a working length of the second sex toy body 21 according to the working length instruction, and controls the vibration module 23 to control a work speed of the second sex toy body 21 according to the work force intensity instruction.

As shown in FIG. 2, in a preferred embodiment of the invention, the interaction system for sex toys further comprises a first intelligent mobile terminal 5, wherein the first sex toy 1 establishes a communication connection with the first intelligent mobile terminal 5, and the first sex toy 1 uploads information to the cloud server 3 through the first intelligent mobile terminal 5. The specific implementation process is as follows: the first intelligent mobile terminal 5 is provided with an exclusive APP or applet, the first sex toy 1 is connected to the first intelligent mobile terminal 5 through the first communication module 13, the acquired use parameters of the first sex toy 1 are uploaded to the exclusive APP or applet of the first intelligent mobile terminal 5, and the first intelligent mobile terminal 5 transmits the use parameters of the first sex toy 1 to the cloud server 3 through the APP or applet.

As shown in FIG. 2, in a preferred embodiment of the invention, the interaction system for sex toys further comprises a second intelligent mobile terminal 6, and the second sex toy 2 establishes a communication connection with the second intelligent mobile terminal 6 and acquires information sent from the cloud server 3 through the second intelligent mobile terminal 6. The specific implementation process is as follows: the second intelligent mobile terminal 6 is provided with an exclusive APP or applet, the second sex toy 2 is connected to the second intelligent mobile terminal 6 through the second communication module 24, the cloud server 3 transmits the generated running instruction of the second sex toy 2 to the APP or applet of the second intelligent mobile terminal 6, and then the second intelligent mobile terminal 6 transmits the running instruction of the second sex toy 2 to the second sex toy 2.

As shown in FIG. 2, in a preferred embodiment of the invention, the first sex toy 1 further comprises a pressure sensor 14, and the first sex toy 1 acquires a work force intensity parameter of the first sex toy body 11 through the pressure sensor 14. The work force intensity parameter is also a use parameter of the first sex toy 1, and by uploading the work force intensity parameter, the cloud server generates a work force intensity instruction of the second sex toy body 21 according to the work force intensity parameter to control the work force intensity of the second sex toy body 21.

As shown in FIG. 2, in a preferred embodiment of the invention, the first sex toy 1 further comprises a temperature sensor 15, and a working temperature of the first sex toy 1 is acquired by the temperature sensor 15. The working temperature is also a use parameter of the first sex toy 1, and by uploading the working temperature, the cloud server generates a use temperature instruction of the second sex toy body 21 according to the working temperature, and controls the use temperature of the second sex toy body 21 through a heating module 25.

As shown in FIG. 2, in a preferred embodiment of the invention, the interaction system for sex toys further comprises an infrared sensor 16, and one or more of use action and shape parameters of the first sex toy 1 are acquired by the infrared sensor. The specific implementation process is as follows: the infrared sensor 16 is disposed on the first sex toy body 11, and use action and shape parameters of the first sex toy body 11 are acquired by the infrared sensor. All these parameters are use parameters of the first sex toy 1 and are uploaded to the cloud server 3, and the cloud server 3 generates use action and shape instructions of the second sex toy body 21 according to the parameters acquired by the infrared sensor to control the motion and shape of the second sex toy body 21.

As shown in FIG. 2, in a preferred embodiment of the invention, the interaction system for sex toys further comprises a second intelligent mobile terminal 6, and the second sex toy 2 establishes a communication connection with the second intelligent mobile terminal 6 and acquires multiple running instructions generated according to parameter information of the first sex toy 1 through the second intelligent mobile terminal 6. The specific implementation process is as follows: use parameters of multiple first sex toys 1 are uploaded to the cloud server 3, the cloud server 3 generates running instructions according to parameter information of the first sex toys 1 and sends the running instructions to the second intelligent mobile terminal 6, in this process, the cloud server 43 may send the multiple running instructions to the second intelligent mobile terminal 6, and users select one or more second sex toys matched with the first sex toys for use through the second intelligent mobile terminal 6.

As shown in FIG. 2, in a preferred embodiment of the invention, multiple first sex toys 1 are configured, multiple second sex toys 2 are configured, and one or more of the first sex toys 1 are used in cooperation with one or more of the second sex toys 2 separately. One or more of the first sex toys 1 are associated with one or more of the second sex toys 2 through hardware setting pairing or software selection. During use, one or more of the first sex toys 1 are used in cooperation with one or more of the second sex toys 2. For example, the use parameters of one of the first sex toys 1 are sent to the cloud server, then the cloud server generates a running instruction, and the running instruction may be sent to one or more of the second sex toys 2, so that one or more of the second sex toys 2 execute the running instruction.

The invention has the following technical effects: an interaction method and system for sex toys are constructed; the interaction method for sex toys comprises the following steps: acquiring use parameters of a first sex toy 1; acquiring a working length parameter and a work speed parameter of the first sex toy 1 by a displacement sensor 12; uploading the use parameters of the first sex toy 1: uploading the use parameters of the first sex toy 1, including the working length parameter of the first sex toy 1 and the work speed parameter of the first sex toy 1, to a cloud server 3 through a first communication module 13; issuing instructions according to the acquired use parameters: generating, by the cloud server 3, a running instruction according to the received use parameters of the first sex toy 1, generating, by the cloud server 3, a work speed instruction of the second sex toy 2 according to the work speed parameter of the cloud server 3, generating, by the cloud server 3, a working length instruction of the second sex toy 2 according to the working length parameter, and sending the running instruction of the second sex toy 3 matched with the first sex toy 1; and running the second sex toy 2 according to the instructions: running the second sex toy 2 according to the received running instruction to control a work speed and a working length of the second sex toy 2. By adoption of the interaction method and system for sex toys, sex toys can be remotely or separately used by users more conveniently based on a network, and the user experience is better.

The foregoing provides a further detailed description of the invention in conjunction with preferred embodiments, but the specific embodiments of the invention are not limited to the above description. Those ordinarily skilled in the art can make several simple deductions or substitutions without departing from the concept of the invention, and all these deductions or substitutions should fall within the protection scope of the invention.

What is claimed is:

1. An interaction method for sex toys, comprising the following steps:
acquiring use parameters of a first sex toy: acquiring a working length parameter of the first sex toy and a work speed parameter of the first sex toy by a displacement sensor;
uploading the use parameters of the first sex toy: uploading the use parameters of the first sex toy, including the working length parameter of the first sex toy and the work speed parameter of the first sex toy, to a cloud server through a first communication module;
issuing instructions according to the acquired use parameters: generating, by the cloud server, a running instruction according to the received use parameters of the first sex toy, generating, by the cloud server, a work speed instruction of a second sex toy according to the work speed parameter, generating, by the cloud server, a working length instruction of the second sex toy according to the working length parameter, and sending the running instruction to the second sex toy matched with the first sex toy; and
running the second sex toy according to the instructions: running the second sex toy according to the received running instruction to control a work speed and a working length of the second sex toy.

2. The interaction method for sex toys according to claim 1, further comprising: establishing a communication connection between the first sex toy and a first intelligent mobile terminal, and uploading information to the cloud server through the first intelligent mobile terminal.

3. The interaction method for sex toys according to claim 1, further comprising: establishing a communication connection between the second sex toy and a second intelligent mobile terminal, and acquiring information sent from the cloud server through the second intelligent mobile terminal.

4. The interaction method for sex toys according to claim 1, further comprising: acquiring a work force intensity parameter of the first sex toy by a pressure sensor.

5. The interaction method for sex toys according to claim 1, further comprising: acquiring a working temperature of the first toy by a temperature sensor, or acquiring one or more of use action and shape parameters of a first sex toy body by an infrared sensor.

6. An interaction system for sex toys, comprising:
a first sex toy, a second sex toy, and a cloud server, wherein:
the first sex toy comprises a first sex toy body, and a displacement sensor and a first communication module disposed in the first sex toy body;
the second sex toy comprises a second sex toy body, and a drive module, a vibration module and a second communication module disposed in the second sex toy body;
the displacement sensor acquires a working length parameter of the first sex toy body then acquires a work speed parameter of the first sex toy;
the first communication module uploads use parameters of the first sex toy to the cloud server, and the use parameters include a work force intensity parameter of the first sex toy and a working length parameter of the first sex toy;
the cloud server generates a running instruction according to the received use parameters of the first sex toy, generates a work speed instruction of the second sex toy according to the work speed parameter and generates a working length instruction of the second sex toy according to the working length parameter, and the second communication module sends the running instruction to the second sex toy matched with the first sex toy; and
the second sex toy runs according to the received running instruction, controls the drive module to control a working length of the second sex toy body according to the working length instruction, and controls the vibration module to control a work speed of the second sex toy body according to a work force intensity instruction.

7. The interaction system for sex toys according to claim 6, further comprising a first intelligent mobile terminal, wherein the first sex toy establishes a communication connection with the first intelligent mobile terminal and uploads information to the cloud server through the first intelligent mobile terminal.

8. The interaction system for sex toys according to claim 6, further comprising a second intelligent mobile terminal, wherein the second sex toy establishes a communication connection with the second intelligent mobile terminal and acquires information sent from the cloud server through the second intelligent mobile terminal.

9. The interaction system for sex toys according to claim 6, the first sex toy further comprises a pressure sensor, and the first sex toy acquires a work force intensity parameter of the first sex toy body through the pressure sensor.

10. The interaction system for sex toys according to claim 6, further comprising a second intelligent mobile terminal, wherein the second sex toy establishes a communication connection with the second intelligent mobile terminal and acquires multiple running instructions generated according to parameter information of the first sex toy through the second intelligent mobile terminal.

11. The interaction system for sex toys according to claim 6, wherein multiple first sex toys are configured, multiple second sex toys are configured, and one or more of the first sex toys are used in cooperation with one or more of the second sex toys separately.
